(19) United States
(12) Patent Application Publication
(10) Pub. No.: US 2013/0069949 A1
(43) Pub. Date: Mar. 21, 2013

(54) SYSTEM AND METHOD FOR GENERATING, PROCESSING AND DISPLAYING DATA RELATING TO CONSUMPTION DATA

(71) Applicant: Ron Samuel Dembo, Toronto (CA)

(72) Inventor: Ron Samuel Dembo, Toronto (CA)

(73) Assignee: Zerofootprint Software Inc.

(21) Appl. No.: 13/601,424

(22) Filed: Aug. 31, 2012

Related U.S. Application Data
(63) Continuation-in-part of application No. 13/233,519, filed on Sep. 15, 2011.

(51) Int. Cl. G06T 11/20

(52) U.S. Cl. 345/440

(57) ABSTRACT

A system, method and device for generating and processing data are provided. The method comprises: generating a first graphical representation of data, such as consumption data, over a period of time with band showing ranges of consumption at various times and generating a second graphical representation of the data as a snapshot of the consumption data a target time in the period of time.

### RELATED APPLICATION

This application is a continuation-in-part application of U.S. patent application Ser. No. 13/233,519 filed on Sep. 15, 2011.

### FIELD OF DISCLOSURE

The disclosure relates generally to a system and method for generating, retrieving, processing and displaying data, with a particular implementation that processes resource consumption data.

### BACKGROUND OF DISCLOSURE

In prior art data processing and analysis tools, data can be analyzed and shown in a graphical form with a particular datapoint being shown within a range of values, for example, in an x-y graph. Existing data processing and analysis tools generate graphics that, while accurate, do not quickly convey relative information regarding a datapoint against various range(s) of data.

There is a need to address deficiencies in the prior art.

### BRIEF DESCRIPTION OF THE DRAWINGS

Embodiments of the disclosure will now be described, by way of example only, with reference to the accompanying drawings, in which:

FIG. 1 is a schematic diagram of a network with a server and a device providing data analysis according to an embodiment;

FIG. 2 is a block diagram of the server and device of FIG. 1 according to an embodiment;

FIG. 3 is a flowchart of a data process executed by the server of FIG. 1 according to an embodiment;

FIG. 4 is a flowchart of a data visualization process executed by the server of FIG. 1 according to an embodiment;

FIG. 5 is a first representative data visualization output in a graphical representation generated by the server of FIG. 1 according to an embodiment;

FIG. 6 is a second representative data visualization output in a graphical representation generated by the server of FIG. 1 according to an embodiment;

FIG. 7 is a third representative data visualization output in a graphical representation generated by the server of FIG. 1 according to an embodiment;

FIG. 8a is a fourth representative data visualization output in a graphical representation generated by the server of FIG. 1 according to an embodiment;

FIG. 8a (ii) is an expanded view of part of the fourth representative data visualization output graphical representation generated by the server of FIG. 1 according to an embodiment;

FIG. 8b is another version of part of the fourth representative graphical representation generated by the server of 1 according to an embodiment;

FIG. 8c is yet another version of part of the fourth representative graphical representation generated by the server of 1 according to an embodiment;

FIG. 9 is a flowchart of another data graphing process executed by the server of FIG. 1 according to an embodiment;

FIG. 10 is a flowchart of a data interpolation process executed by the server of FIG. 1 according to an embodiment;

FIG. 11 is a flowchart of a data extrapolation process executed by the server of FIG. 1 according to an embodiment; and

FIG. 12 is a flowchart of a data scenario process executed by the server of FIG. 1 according to an embodiment.

### DESCRIPTION OF EMBODIMENTS

The description which follows and the embodiments described therein are provided by way of illustration of an example or examples of particular embodiments of principles of the present disclosure. These examples are provided for the purposes of explanation and not limitation of those principles and of the disclosure. In the description which follows, like parts are marked throughout the specification and the drawings with the same respective reference numerals.

An embodiment generally provides a system, method and device for generating, retrieving, processing and displaying data, with an implementation that processes resource consumption data in a set of datapoints. One feature of an embodiment generates visual representations of consumption data for a datapoint in a time frame and provides visual cues for gauging the relative consumption at a given time within statistical models and data interpolation and extrapolation features. Another feature of an embodiment generates visual representations of consumption data for a datapoint in the set with visual cues providing comparisons to consumption data of one or more peers in the set. As part of that feature, the visual representation can provide a scale indicating a total range of values for the datapoints in the set (e.g. from a minimum to maximum value(s)) and an indicator of relative usage values (e.g. visual cues indicating distributions of values within the set).

In a first aspect, a method of processing data is provided. The method comprises: determining a start time and an end time in a set of datapoints comprising a plurality of data relating to a plurality of times; generating a first graphical representation of the set of datapoints on an output device and generating a second graphical representation of the datapoints at a target time on the output device with the first graphical representation. The first graphical representation includes: a time axis; a value axis; a plot of the set of datapoints between the start time and the end time; a plot of a first band relating to the set of datapoints between the start time and the end time; a plot of a second band relating to the set of datapoints between the start time and the end time; a plot of a first boundary of a first band of values relating to the set of datapoints between the start time and the end time; a plot of a second boundary of a second band of values relating to the set of datapoints between the start time and the end time; and a cursor for marking the target time between the start time and the end time. The second graphical representation includes: an axis for a scale for a range of values for the set of datapoints at the target time; a first marker a first boundary for a first segment in a scale for a range of values for the set of datapoints at the target time; a first graphical feature representing the first segment, the first graphical feature spanning a first length along the axis; a second graphical feature representing a second segment in the set of datapoints, the second graphical feature spanning a second length along the axis; and a first indicator for a first datapoint at the target time.

The method may further comprise: for the plot of the set of datapoints in the first graphical representation, interpolating datapoints for values between a third time and a fourth time where data is not available for a period of time.

The method may further comprise: for the plot of the set of datapoints in the first graphical representation, extrapolating datapoints for values after a third time when data from the datapoints after that third time is not available.

In the method, the plot of the first boundary of the first band of values relating may be determined from a factor of a standard deviation from a mean value for the set of datapoints between the start time and the end time.

In the method, the standard deviation may be based on a normal distribution for the set of datapoints.

In the method, the scale may have a plurality of markers that are consistent in scale between the start point and the end point.

In the method, the second length may be approximately equal to the first length; and the range of datapoints of the first segment may have a different scale to a range of datapoints in the second segment.

The method may further comprise generating in the graphical representation a second indicator for a second datapoint in the set of datapoints. For the method, the second datapoint may represent a target value or a historic value for the first datapoint.

The method may further comprise generating a second graphical representation with the graphical representation for a second set of datapoints. For the method, the second set of datapoints may relate to the consumption data or other data, but the second set of datapoints may relate to a timeframe that differs from the timeframe associated with the first set of datapoints.

In the method, the first graphical feature may be provided in a first colour; and the second graphical feature may be provided in a second colour.

In the method, the first colour may be green; and the first segment may represent a range of target values in the set of datapoints. Alternatively, the first segment may represent actual values.

In the method, the set of datapoints may represent consumption data for a resource; and the first datapoint may represent consumption of the resource at a location. Alternatively, the set of datapoints may represent cost or emission data for a resource.

The method may further comprise: analyzing model data to identify a goal for consumption of the resource at the location; and generating in the graphical representation a second indicator for the goal or historical data.

The method may further comprise determining a progression rate to change usage of the resource at the location from the first datapoint to the goal.

The method may further comprise generating control signals to control a device to implement the progression rate.

In the method, the goal may be based on at least one of time of using savings and a rebate program.

In the method, the model data may include goal data based on at least one of time of using savings and a rebate program.

In another aspect a system for processing data is provided. The system comprises: a processor; a display device; a first module to provide instructions for the processor to process a set of datapoints to generate a first graphical representation of the datapoints on the display device; a second module to provide instructions for the processor to process the set of datapoints; and a third module to provide instructions for the processor to generate a second graphical representation of the datapoints for the display device, by generating data for the second graphical representation with the first graphical representation. The first graphical representation includes: a time axis; a value axis; a plot of the set of datapoints between the start time and the end time; a plot of a first band relating to the set datapoints between the start time and the end time; a plot of a second band relating to the set of datapoints between the start time and the end time; a plot of a first boundary of a first band of values relating to the set of datapoints between the start time and the end time; a plot of a second boundary of a second band of values relating to the set of datapoints between the start time and the end time; and a cursor for marking a target time between the start time and the end time. The second module includes instructions to: determine a scale for a range of values of the set of datapoints at the target time; determine a first segment in the range of values of the set of datapoints at the target time; and determine a second segment in the range of values of the set of datapoints at the target time. The third module generates data for the second graphical representation relating to: an axis for the scale; a first marker for the first boundary; a first graphical feature representing the first segment, the first graphical feature spanning a first length along the axis; a second graphical feature representing the second segment, the second graphical feature spanning a second length along the axis; and a first indicator for a first datapoint in the set of datapoints.

The system may comprise a fourth module to: analyze model data to identify a goal for consumption of the resource at the location; and generate additional data for the graphical representation for a second indicator for the goal.

In the system the second length may be approximately equal to the first length; and the range of datapoints of the first segment may have a different scale to a range of datapoints in the second segment.

In the system, the third module may: generate data to produce the first graphical feature in a first colour; and generate data to produce the second graphical feature in a second colour. For the system, the first segment may represent a range of target or actual values in the set of datapoints.

In the system, the data and the additional data for the graphical representation may be provided to the output device. The output device may be a display associated with a device in communication with the system.

The system may further comprise a fourth module to utilize the goal and the first datapoint to control operation parameters of one device at the location.

In other aspects, various combinations of sets and subsets of the above aspects are provided.

Now, a description is provided of general features of an embodiment through an exemplary system implementing same through a server in communication with a device over a network. Thereafter a description is provided on details of an embodiment.

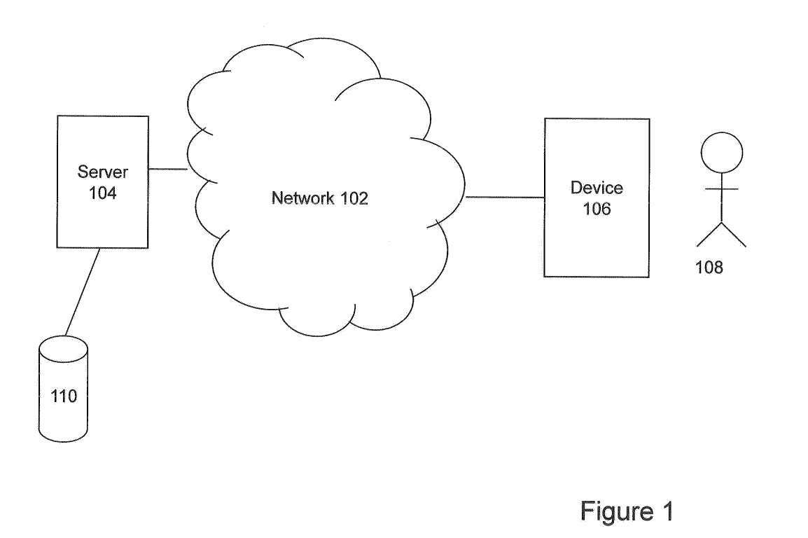

FIG. 1 shows system 100 where network 102 provides data and control communications between elements connected thereto, including server 104 and device 106. User 108 is located at device 106 can operate same and can see any output generated at its display (not shown). In this embodiment, server 104 provides data collection, storage, processing and analysis features of an embodiment. Database 110 is connected to server 104 and provides a repository for data for server 104. Device 106 is configured to access server 104, initiate commands for server 104 to conduct analysis on data from database 110 and process the data and generate graphical representations of aspects of the data analysis on its display for viewing by user 108.

Network 102 can be implemented in any known architecture, providing wired and/or wireless connections to its elements, and including one or more interface servers (not shown) that may allow network 102, and its elements, to be in communication with other networks and their elements. Network 102 may be implemented as a local area network (LAN) that provides local wired connections to its elements. Network 102 may be connected to the Internet (not shown) via an interface server (not shown). Network 102 may also be a Wi-Fi network generally following standards set by the IEEE LAN/MAN Standards Committee, known as IEEE 802, through its working group “11”. Security features may be provided by network 102. For example, access to its systems may be provided through secure protocols/links, e.g. through a Hypertext Transfer Protocol Secure (HTTPS) scheme.

With features of exemplary network 102 and selected elements provided, further detail is provided on server 104 and device 106. Each is described in turn.

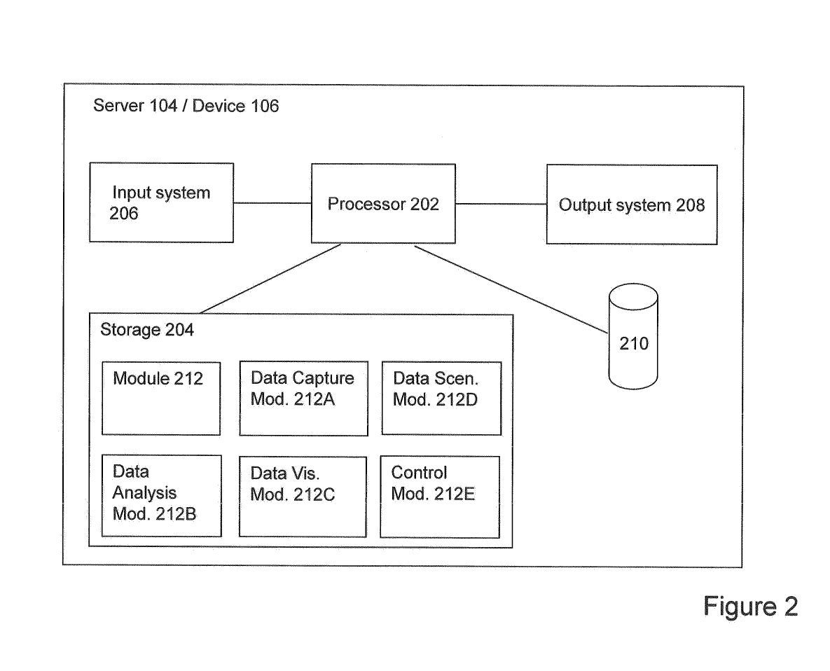

For server 104, FIG. 2 illustrates details of its internal components. In an embodiment, server 104 is a processor-based computing platform. It may have the form factor of a rack-mounted, desktop or laptop computer. It may be a minicomputer. It may be a virtual computing device comprising processing modules that are installed on one or more devices.

Within server 104, there is processor 202, memory 204, input system 206, output system 208, and storage system 210. Processor 202 controls the overall operation of server 104 through instructions provided to it that are typically stored in its memory 204 and/or storage system 208. Exemplary processors for processor 202 may include “x86”—compatible processors (trade-mark) available from Intel Corporation. Memory 204 may be dynamic random-access memory, flash memory or other volatile and non-volatile storage devices. Controlling overall operating of processor 202 (and as such, server 104), an operating system (OS) is provided that may be stored in memory 204. An exemplary OS is Windows Server (trade-mark) by Microsoft Corporation.

Software modules 212 provide a series of program instructions to execute various commands on processor 202. Such modules are typically stored in either memory 204 and/or storage system 210. In an embodiment, software modules include data capture module 212A, data analysis module 212B, data visualization module 212C, data scenario module 212D and control module 212E. Further details on these software modules are provided below.

Input system 206 is part of a class of components for receiving data input by server 104. Input system 206 may a keyboard, mouse device, trackball, touchpad, touch screen, microphone, accelerometer, lightpen or other device. Input system 206 may also include a component that receives data over network 102 or via application programming interfaces (APIs). Input system 206 may also include a component configured to receive electronic data from a monitoring device, such as a utility meter, smart meter, water meter, volt meter, amperage meter, light meter, wind meter, hydrometer, etc. Input system 206 may be an indirect data capturing system. For example, system 206 may be camera that records images of a meter, capturing changes in its readings. Processes may then be provided to analyse the images and extract the data readings from them.

Output system 208 may be a component for transmitting data to an internal or external component or device to server 104. Output system 208 may include a display, speaker or printer. Output system 208 may also include a network component configured to transmit data to an external device, through a connection and/or through network 102. Output system 208 may also include a component configured to transmit data directly to another device, such as a laptop computer directly connected to output system 208.

Storage system 210 stores data and may be internal to server 104; it may be comparable to storage 110 (FIG. 1). Alternatively, storage system 210 may be external to server 104. Where storage system 210 is external to server 104, storage system 210 may be in direct communication with server 104 or in communication with server 104 via a network (not shown), such as a LAN. Storage system 210 may comprise any type of appropriate physical storage medium, such as hard drives and/or flash memory. Access to data in storage system 210 may be controlled through software operating system on and/or through system 210, such as through a database application, such as Access (trade-mark) or SQL.

Turning now to device 106, it has similar components to server 104. As such, FIG. 2 may be used to represent corresponding components of device 106. Again, device 106 is a processor-based electronic computing device. It may by a computer, laptop computer, minicomputer, tablet computing device, smart phone, personal digital assistant (PDA) or other computing device. Device 106 may have internal components that are analogous to internal components of server 104, including processor 202, memory 204, input system 206, output system 208 and storage system 210. In particular, device 106 may comprise a network component (as part of its input system 208) for receiving a data from server 104 and display and/or print as part of its output system 208.

In another embodiment, server 104 and device 106 may comprise a single device, and in such embodiments.

Now, with components of system 100 disclosed, further detail is provided on exemplary processes and methods for processing and generating graphical representations of data by an embodiment.

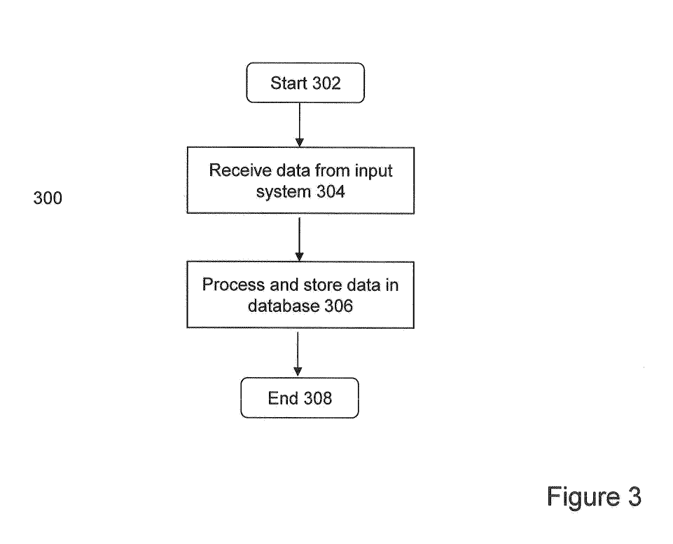

First, referring to FIG. 3, flow chart 300 shows an exemplary data capture process in receiving data by an embodiment. It may be executed or controlled in whole or in part by server 104. Therein, data capture module 212A (FIG. 2) may provide programming code for execution on processor 202 (FIG. 2) to effect execution of the process. The process may also operate in whole or in part on device 106.

As noted above, an embodiment generates visual graphical representations of data, in particular consumption, cost or emission data. Such data can be provided from any data capturing device (e.g. a smart gas meter, smart electric meter, utility meter, water meter, volt meter, amperage meter, light meter, wind meter, volatile organic compound (VOC) sensor, oxygen sensor, carbon dioxide sensor, air quality sensor etc.) or any data source (e.g. tabular data such as historic daily temperature readings, daily resource consumption data, etc.). Data can be collected and stored at a central or distributed system through network 102. Transmitted data can contain a data value and additional information (e.g. information relating to the source of the data, the entity generating the data, the location, time, ambient conditions, etc.). The data may relate to usage data from utility bills, data received from utility meters, bulk information received from third-party databases or data submitted by third-parties via an API made available by input system 206. After start process 302, such data is received from an input system in process 304.

The data may reflect instantaneous usage data, data gathered over a time period, change data, rate of change data, projection data of usage or other values. For instance, the data may indicate a rate of water usage every hour, on the hour, for a particular household, the data being a negative or positive value representing the difference in rate for the present point in time, as compared to an earlier point in time. Additional data that may be provided includes identifying information about the data source, e.g. serial number of device, street address for house for meter, size information for house, weather data for the day, utility prices for the day, etc.

Next at process 306, the data is processed and stored. This may involve tagging the data with a timestamp and source details and may involve storing the data in a certain section of database 110. Some data may be discarded without being stored, for example, if the data is out of range, corrupted, inconsistent, erroneous or invalid. In one embodiment, the received data is converted into standardized units before storage. For example, data capture module 212A may receive data comprising a first household's usage of natural gas in cubic feet over the course of every hour, and a second household's usage of natural gas as an instantaneous rate in litres/minute, at the start of every minute. Data capture module 212A may convert this data into pre-determined standardized units, such as cubic meters per day, including by applying standard estimation techniques such as interpolation or extrapolation, as necessary.

Once the received data is stored, it may be accessed as a data element from database 110. For the purpose of convenience and not limitation, a stored data element in database 110 per flow chart 300 may be referred to as a datapoint. Database 110 contains multiple different datapoints. A collection of datapoints (grouped by applicable parameters), is referred to herein as a dataset for the purpose of convenience and not limitation. There may be multiple datasets within database 110. Flow chart 300 ends at process 308.

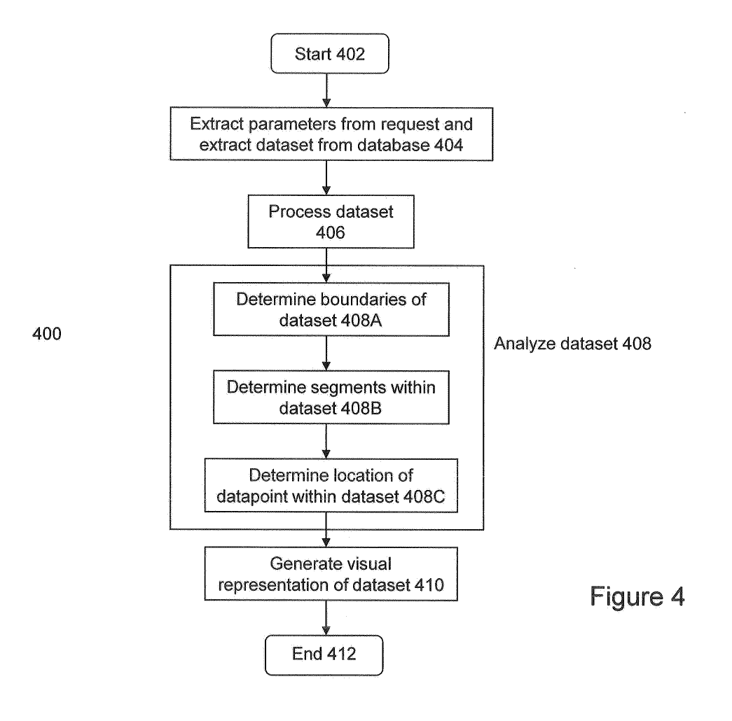

Next, referring to FIG. 4 flow chart 400 shows an exemplary data analysis process for analyzing captured data by an embodiment. Again, the process is described as operating on server 104, but it may also operate in whole or in part on device 106. For server 104, data analysis module 212B (FIG. 2) may provide programming code for execution on processor 202 (FIG. 2) to effect execution of the process. One or more servers 104 and/or devices 106 may maintain a web site that produces visual representations of datasets based on inputs provided to the web site. Such a web site may be accessed by any device connected to the Internet. One or more processes of flow chart 400 may be executed on a “thin” or a “thick” client in network 102, depending on computing power, storage capacity and/or network connections of the client.

The process starts at process 402, which may be initiated on a periodic basis (e.g. once an hour, once a day, every night, etc.) and/or on an event basis, such from a request from an external device, such as device 106 or from a software module operating on server 104 and/or device 106. As part of start process, a set of parameters for a visualization request are provided. The parameters may have been preset, as a default, or may be provided with the request itself. A graphical user interface (GUI) may be provided on device 106 showing an interface on its display providing options and fields for user 108 to define the parameters for the request.

At process 404, parameters from the request are used to determine what data is extracted. As an example, the parameters may include one or more of: a time boundary (e.g. data from today, last hour, this spring, this year, last year, etc.); a device reading identifier (e.g. readings from one or more power meters from a first residence, power meters, carbon meters, water meters, wind meters, temperature meters, humidity meters, barometers, etc.); a geographic/location boundary (e.g. reading from one residence, residences in a city block, residences in a postal code, a cottage, an industrial complex, one or more rooms within a building, one or more specified industrial plants, etc.) and other ad hoc parameters (e.g. only meters of a particular brand).

A database command is built from the request and its parameters and a database query is sent to a target database, such as database 110, to retrieve a dataset populated with records in the database that match the request.

Next at process 406, the retrieved dataset is processed. Part of the processing may include filtering the data. This may be an optional process. Filtering may eliminate extraneous datapoints in the dataset. For example, filtering may eliminate datapoints that are above and/or below a threshold, or that are outside a given time or geographic parameter. The filter parameters may be set in the search parameters and/or there may be a default set of filtering parameters accessed by the system.

The retrieved dataset may contain data from multiple sources relating to different consumption or usage data over a particular time period. Part of the filtering may include making adjustments to the dataset to level, normalize and/or localize the data.

Levelling adjusts the dataset to correct for different coverage of different data sources, to facilitate comparison of datapoints. For example, if the dataset includes consumption data for a source over a particular time period, in some circumstances, consumption data for that time period may not be available from other sources. As such, the dataset may be filtered to utilize datapoints that are complete over a time period for all sources. Alternatively, values for missing or incorrect values may be interpolated or extrapolated from similar data.

Normalizing data adjusts the dataset so that comparisons can be made for different data sources. As such, readings for a site spanning a number of days/weeks/seasons can be normalized to unitized values to allow them to be more easily compared. Also, readings from different locations can be normalized to unitized values to allow them to be more easily compared. For example, a dataset may include consumption data for a time period from multiple sources. In some circumstances, the sources may have different attributes that may affect consumption values. For example, a data source may correspond to a household with multiple occupants, whereas another data source may correspond to a household with a single occupant. The dataset may be adjusted so that consumption usage is calculated on a per household occupant basis. Data for differently sized locations can be normalized to a per square foot/meter basis to allow comparison. Normalizations can performed to include more than one factor (e.g. data can be recalculated to be presented on a per square foot and a per occupant basis).

As part of normalizing consumption data, a balance point may be used, representing a ‘normal’ value for a factor relating to the data. For example for energy consumption data relating to heating a building, the balance point for heating a building may be a baseline building temperature at which the building does not need to be heated internally. If the building temperature is above that baseline, then the building does not require internal heating. The building temperature can include readings from external temperatures, internal ambient temperature and/or the temperature of the frame of the building. In a given winter, a building's heating balance point may be constant, but the heating may be activated for longer or shorter periods over the winter depending on the outdoor temperature. The difference between the current building temperature and the balance point can be used as a factor in normalizing the data. Additional factors can be provided once the difference is calculated. When the heating consumption data is normalized, extra energy usage for heat on colder days can be normalized against less energy usage for heat on warmer days. Comparable normalization calculations can be provided for energy usage for cooling a building.

Localization adjusts values of the datapoints to correspond to a particular user's actual or predicted preferences. For example, values may be stored in storage system 210 in standardized units such as cubic meters, whereas if system 100 is aware that user 108 is located in the United States, data analysis module 214 may adjust all values to be in cubic feet, instead of cubic meters. Other types of localization adjustments that adjust and/or normalize the dataset may be provided. Localization may adjust values in the dataset to local parameters (e.g. the local time zone, the local currency, etc.).

As another example, datasets may be filtered to take into account weather or seasonal effects. Adjustments may also be made for a given data source in view of a change to the data source over a period of time. For example if a household replaces its furnace then an adjustment may be made for consumption data before the replacement. It will be appreciated that other filtering and adjustments can be made.

The retrieved dataset may be filtered to account for any permission levels of the entity making the request. For example, the request from process 404 may originate from a school and the target analysis may be for energy usage of the school against its peers. The extracted dataset may collect energy usage records for all schools in a relevant district. The filtering may then identify the relevant peers (based on school board information, postal codes, etc.). Filtering may also remove outliers from the retrieved dataset. For example, data records that do not show any usage of electricity could be removed from a data set on the basis that such data records are clearly outliers, and unlikely to be accurate data.

In some instances, the data may contain multiple values directly related to consumption or usage. For example, a data record may indicate for a particular household and a particular time period both usage of electricity and natural gas during that time period. With such data, a sort/filter may be applied to extract the relevant datapoint(s).

It will be appreciated that any of the filtering processes described herein may be conducted by either server 104 and/or device 106. In some instances, such processes may be conducted at any time prior to generation of the visual representation of the dataset.

Upon completion of the filtering processes, next at process 408, the filtered dataset is analyzed. In one embodiment the data is analyzed to identify segments in the dataset which can be used to indicate notable parts of the dataset when a visual representation of the dataset is generated. As part of the analysis one or more of the following determinations may be made, in any order.

A first determination may be to identify boundaries of the dataset, per process 408A. This may include identifying the start and end datapoints. The parameters for the end points may be based on time parameters (e.g. start and end times) or value parameters (e.g. minimum and maximum values). A scale may be determined for the range of values for datapoints between the start and end datapoints. This may have been done at the filtering process. With a scale and one or more end points determined for the dataset, a range of values can be established for the dataset when a visual representation is made of it.

A second determination may be to identify one or more segments and their boundaries with the dataset, per process 408B. A segment is a section of the dataset and the two terms can be used interchangeably. One segment or multiple segments may be provided in a dataset. Generally, the segments are sequential, but they do not have to be. A gap may or may not separate segments. The number of segments can be used to group datapoints together (e.g. datapoints above, below or within certain ranges). When a visual representation of the dataset is produced by an embodiment, each segment can be displayed in a contrasting manner to the other segment to visually distinguish the segments from each other. This provides a visual cue to the viewer as to a distribution of datapoints in the dataset. The boundaries for each segment divide the segments into equal parts or non-equal parts. Further detail is provided on the segment determination below.

A third determination may be to identify a location of a specific datapoint in the dataset, per process 408C. As noted above, the dataset may have one or more segments. When a visual representation of the dataset is produced by an embodiment, a value of a target datapoint will determine in which segment it is shown. For example, for an exemplary dataset of meter readings for houses within a city block, meter data for a particular house can be selected. That meter reading's value is shown by an indicator in a visual representation for the meter readings of the city block. This provides a visual cue in the representation of the relative location of that house's meter readings compared to aggregate readings for that block.

Other analyses and determinations for the dataset can be performed in process 408 to complete the data analysis. It will be seen that that an embodiment transforms raw data into a filtered and refined dataset that can be used to generate reports (both on a display and/or as a physical output from a printer). The refined dataset can be used as a basis for providing feedback data that can be used to control a downstream system (e.g. lights, water usage, allocation of resources, etc.).

Next, at process 410 a visual representation of the dataset is produced using the dataset, the boundaries of the dataset, the segments and the location of a given datapoint and any other parameters that have been provided. Any device having access to a dataset (e.g. server 104 and/or device 106) can generate the visualization. The visualization can be generated on a display of a device (e.g. at device 106, server 104 or a remote device to network 102). For server 104 or device 106, data visualization module 212C (FIG. 2) may provide programming code for execution on processor 202 (FIG. 2) to effect execution of the process.

Flow chart 400 ends at process 412.

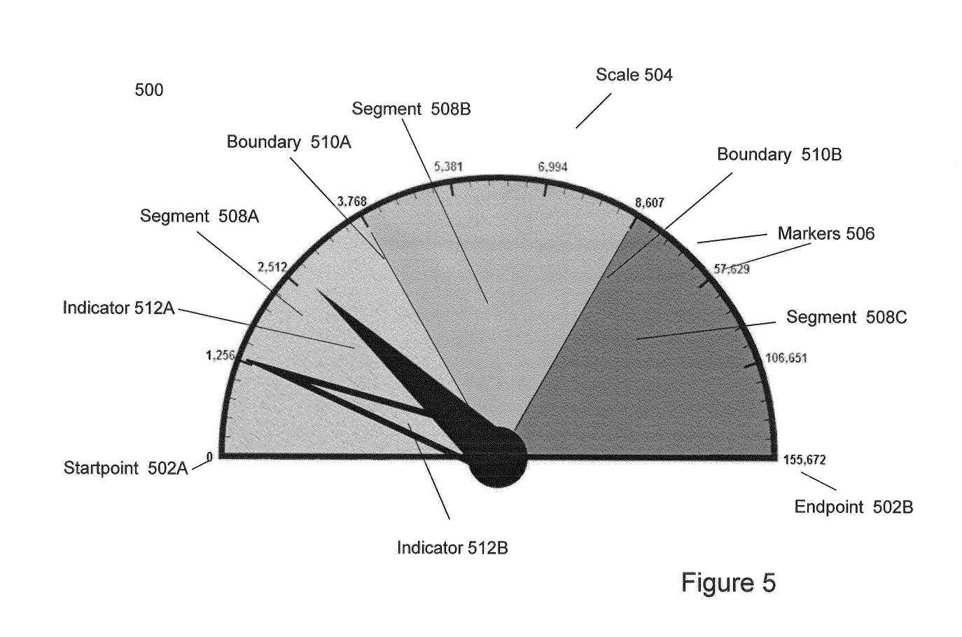

Now further detail is provided on visual representations of datasets provided by an embodiment. Per process 410, an embodiment utilizes the dataset to provide a graphical representation of same. An embodiment can provide a plurality of different visual representations, provided as graphical forms. Exemplary representations are described in FIGS. 5, 6 and 7. Each is discussed in turn.

FIG. 5 shows a first exemplary graphical representation of the output in the graphic form of gauge 500, which may be generated on an output device such as a display and/or a printer. An exemplary dataset used to produce gauge 500 is provided in Table A:

TABLE A

| Datapoint | Value | Note |
|---|---|---|
| N datapoints | values between 0 and | “Best consumption” |
| | 3,768 | range |
| Current household | 2,600 | Current household usage |
| Target household | 1,256 | Target household usage |
| M datapoints | values 3,768 and 8,607 | “Acceptable consump- |
| | | tion” range |
| O datapoints | values 8,607 and 155,672 | “Excessive consump- |
| | | tion” range |
| P datapoints | values over 155,672 | Data out of range |

For an example, gauge 500 shows datapoints relating to energy consumption of homes in a city block. The total number of datapoints would be N+M+O+P. In one embodiment, gauge 500 has a form of a semi-circle, mimicking a layout of a speedometer. Start point 502A is located at the bottom left edge of the bottom of gauge 500, representing the lowest range of data in the dataset. End point 502B is located at the bottom right edge of the bottom of gauge 500, representing the highest range of data in the dataset (namely data having values below 155,672). Scale 504 is located along the perimeter of the semicircle and represents an axis against which datapoints in the set are plotted. Scale 504 also indicates datapoints between the lowest and highest ranges. Markers for specific values in the dataset may be provided on scale 504. It will be appreciated, while gauge 500 appears to be a two dimensional form, the datapoints are effectively in a tabular, one dimensional form, where all datapoints reflect a certain meter reading.

As noted in data analysis process 408C (FIG. 4), segments have been defined for the dataset. The segments can represent one or more segments, dividing the dataset into halves, thirds, quarters, fifths, etc., with each segment being approximately the same size in the visual representation. For gauge 500, an exemplary parameter for process 408C has determined that there will be three segments of approximately equal size (in terms of visual area in gauge 500). As such, boundary 510A at datapoint “3,768” shows a boundary between the first (lowest) third and the middle third for values in the dataset. Boundary 510B at datapoint “8,607” shows a boundary between the middle third and the highest third for values in the dataset. In calculating a value for a boundary values, data analysis module 212A may determine boundary values using statistical analysis tools and calculations, including distribution analysis tools. Such analysis may identify boundaries based on average values, population distribution values (e.g. to identify boundaries where one third of the values are in the lowest third, one third are in the middle third and one third are in the upper third). The boundaries are shown along the axis of scale 504.

Gauge 500 shows the defined segments and their boundaries. For an example where a dataset has three segments, gauge 500 shows three segments 508A, 508B and 508C. Segments 508A and 508B are separated by boundary 510A and segments 508B and 508C are separated by boundary 510B. For ease of identifying segments, different graphical features are used to visually differentiate the segments from each other. In one embodiment, the number of datapoints in each segment is the same or almost the same. Colours can be used to show different segments to provide a visual cue for the relative locations of data within the dataset. Here, segment 508A is shown in green; segment 508B is shown in yellow and segment 508C is shown in red. As such, a “green-yellow-red” colour scheme provides a “go-caution-stop” visual analogy that a viewer can understand and interpret information provided in gauge 500. Each segment can represent a different relative state its datapoints. Datapoints in a “green” segment can represent values having an ideal, target, best and/or preferred value (e.g. least consumption, most efficient, etc.); datapoints in a “yellow” segment can represent values having an acceptable value (e.g. within an average, etc.); and datapoints in a “red” segment can represent values having a non-ideal, worst or least preferred value (e.g. most consumption, least efficient, etc.). Representations and ranges of values may be defined based on the types of data in the datapoints, the number of datapoints, target usage conditions (e.g. based on laws and regulations, such as vehicle emissions regulations) and other factors. Other graphical features can be provided to differentiate segments, e.g. black-white, white-grey, green-red (indicating “go/stop”), rainbow colour schemes, different background patterns in segments (e.g. dots, stripes, stippled lines, etc.), different labels provided for different segments, etc.

Values for the scales and additional marking for graph 500 may have been determined during localization, described above for process 406 (FIG. 4). In one embodiment localization is conducted at server 104 (FIG. 1). In another embodiment, localization is done at device 106 (FIG. 1). Localization can include providing markings for values that adhere to local idioms. For example, either a period “.” or a comma “,” can be used to separate the integer portion of a number from its fractional portion, depending on whether North American or European number marking conventions are used. Similar localization changes may be made to the data to for time, date (e.g. MM/DD/AA or DD/MM/AA formats) and currency idioms.

Other distributions can be provided where there is a segment indicating a preferred range in the dataset and on either side of the preferred range, adjacent segments sequentially less preferred. As such, the colour scheme may have a middle green segment and outward segments appear from yellow to red. Other distributions may have multiple preferred ranges.

The visual presentations can be augmented to show additional data in two and three dimensions. A two dimensional representation may introduce another parameter on another axis (e.g. time or location). For example additional “slices” of gauge 500 may be shown stacked against gauge 500 showing different usage snapshots at different times for the city block or showing different usage snapshots for different city blocks at a given time. A three-dimensional representation may introduce two parameters on two additional axes (e.g. axes showing time and location).

Returning to a basic one-dimensional representation in gauge 500, scale 504 can be linear, non-linear or linear in sections and non-linear in other sections, so that the scale values along scale 504 differ in different sections. Values for such sections can be based in part on the number of segments defined. Markers 506 show values along scale 504 in major and minor increments. In this representation, scale 504 is linearly scaled within each segment 508. For example, in segment 508A markers are calibrated to be approximately 1,256 units apart; in segment 508B markers are calibrated to be approximately 1,613 units apart; and in segment 508C markers are calibrated to be approximately 49,022 units apart. Notably, among the three segments for this exemplary dataset, there is no linearity of calibrations.

Gauge 500 shows an exemplary graphical representation where each segment 508A, 508B and 508C in gauge 500 is approximately of equal size, where each segment spans approximately the same length along the axis of scale 504. However, as noted above each segment may not show an equal range of datapoints along scale 504: each segment covers a range of datapoints in the dataset that may not be linear to a range of datapoints in another segment. For example, while segments 508A, 508B and 508C are approximately of the same size, segment 508A shows to a portion of scale 504 for datapoints having values between 0 and 3,768, segment 508B corresponds to a portion of scale 504 for datapoints between 3,768 and 8,607 and segment 508C corresponds to a portion of scale 504 for datapoints between 8,607 and 155,672. In other embodiments, markers 506 along scale 504 may be presented in different colours, fonts and/or emphasis (e.g. bold, italics) to indicate the different segments.

It will be appreciated that segments 508 and scale 504 of gauge 500 provide an indication of an overall distribution of datapoints within a dataset. Gauge 500 also provides an indication of the location of a particular datapoint within the distribution, through indicator 512. As scale 504 shows a range of datapoints in the collected dataset, indicator 512A provides a visual marker noting a value in scale 504 for a particular datapoint. In gauge 500, indicator 512A is presented as a needle within the speedometer paradigm of gauge 500. Other forms for indicators can be provided (such as a box marker along scale 504). Indicator 512A “points” to a value of around 2,512, representing the energy usage for the “current household” within the block of houses, per Table A. An embodiment also provides a second indicator 512B on gauge 500 that can be used to mark a second value in scale 504. The second value may represent a goal, target and/or historic datapoint (e.g. energy usage for the house last week). Here, the second value represents a Target Household's consumption level, per Table A.

As noted, gauge 500 is shown as a speedometer. In other embodiments other forms of speedometers can be provided. For example, other speedometers can be circular, rectangular, square, oval or linear. General characteristics of a speedometer are that there is a scale having values identified thereon than progress from a first value to a higher value or from a first value to a lower value. The progression may or may not be linear. As noted above, on the speedometer, segments for datapoints can be identified an indicator can be provided showing a current value of a target datapoint. The location of the indicator may be updated periodically depending on updates to the dataset.

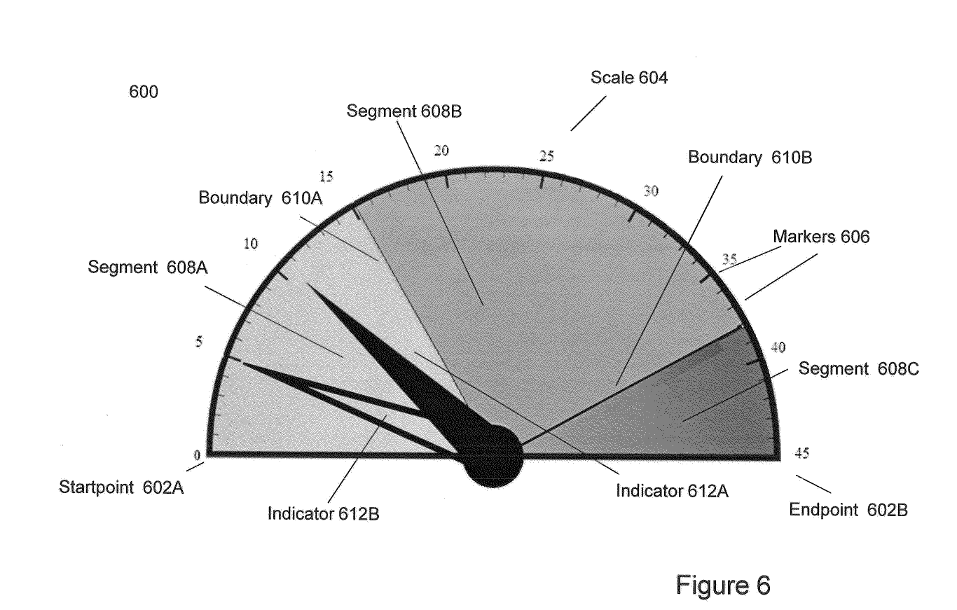

FIG. 6 shows a second exemplary graphical representation of gauge 600. Again, as an example, datapoints for energy usage of houses in a city block are analyzed. Gauge 600 has comparable elements to gauge 500 (FIG. 5), including start point 602A, end point 602B, scale 604, three segments 608A, 608B and 608C, boundaries 610A and 610B and indicators 612A and 612B.

In one embodiment, each segment has an equal number (or close to equal number) of datapoints to one or more or all of the other segments. If one datapoint moves from one segment to another, one datapoint may be moved out so that the number of datapoints remains equal. This also allows the bar to be moved up as the consumption decreases.

One difference between gauge 600 and gauge 500 is that in gauge 600, scale 604 is shown as a linear scale from start point 602A to end point 602B. In other embodiments, scale 604 may show units in a logarithmic or exponential scale. As such depending on boundary definitions for segments 608, segments 608A, 608B and 608C may have different sizes and boundaries 610A and 610B may be located along scale 604 to reflect those different sizes. As shown, segment 608B is larger than segment 608A, which is larger than segment 608C. As such, since segment 608B is the largest, segment 608B shows that it has the widest dispersion of datapoints for the segments.

In another embodiment, segments may have different numbers of datapoints among themselves. The size of a segment may reflect the relative number of datapoints within that segment.

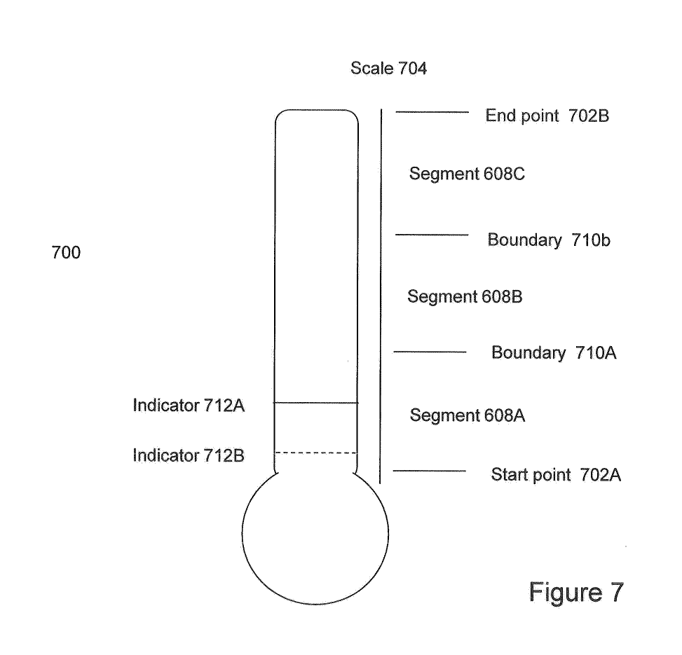

FIG. 7 shows a third exemplary graphical representation of gauge 700, shown as a thermometer. Again, as an example, datapoints for energy usage in a city blocks are analyzed. Gauge 700 has comparable elements to gauges 500 and 600 (FIGS. 5 and 6), including start point 702A, end point 702B, scale 704, three segments 708A, 708B and 708C, boundaries 710A and 710B and indicators 712A and 712B. The values on scale 704 may be non-linear (per FIG. 5) or linear (per FIG. 6).

In other embodiments, output of an analysis of the datapoints may be represented in other graphical representations, such on a line graph, in a pie chart, in a bulls-eye chart, in two- and three-dimensional charts (e.g. a chart having time as one dimension in addition to the usage charts) or other forms. Data may also be presented in a tabular form, where sections of a table may be highlighted to show segments and indicators.

With exemplary visual representations described, further detail is provided on data analysis tools provided by an embodiment.

In particular, an embodiment provides tracking of consumption data and generation of graphs and charts where a large data set is provided. For example, in real-time environments, consumption data (and/or other data) can be gathered and stored for a given site (or collection of sites). An embodiment provides graphical tools to show historic, current and projected levels of consumption. FIGS. 5-7 and their related descriptions provide a snapshot of a current level of consumption/use of the tracked item. The snapshot can be at a certain point in time, such as a current time, a specific previous time, a projected time or an average over a determined period of time. An embodiment provides additional data, in graphical form, where a range data of consumption levels over a period of time tracked in a dataset.

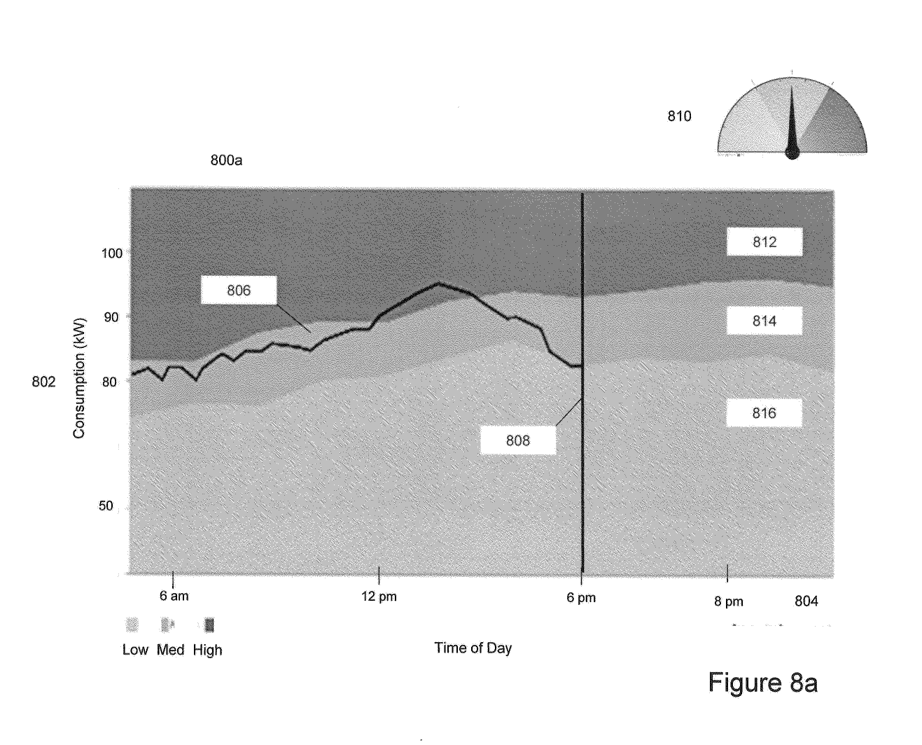

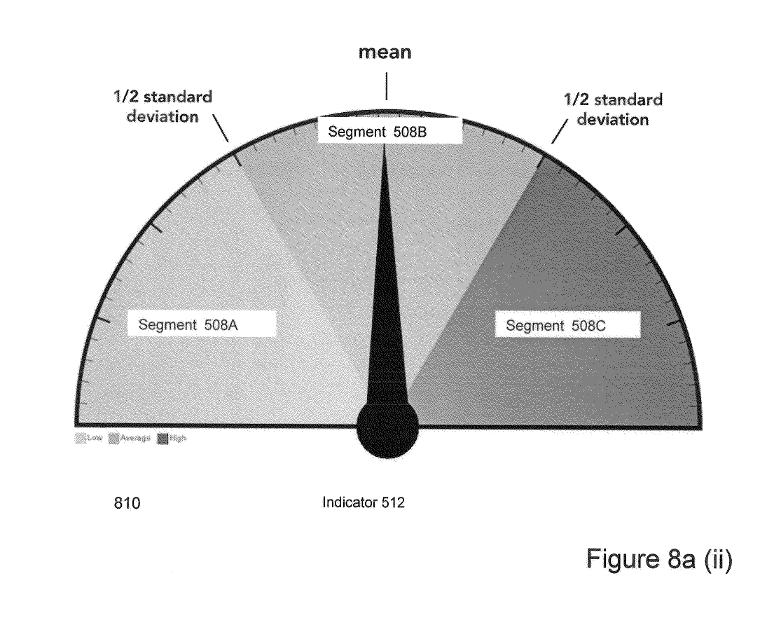

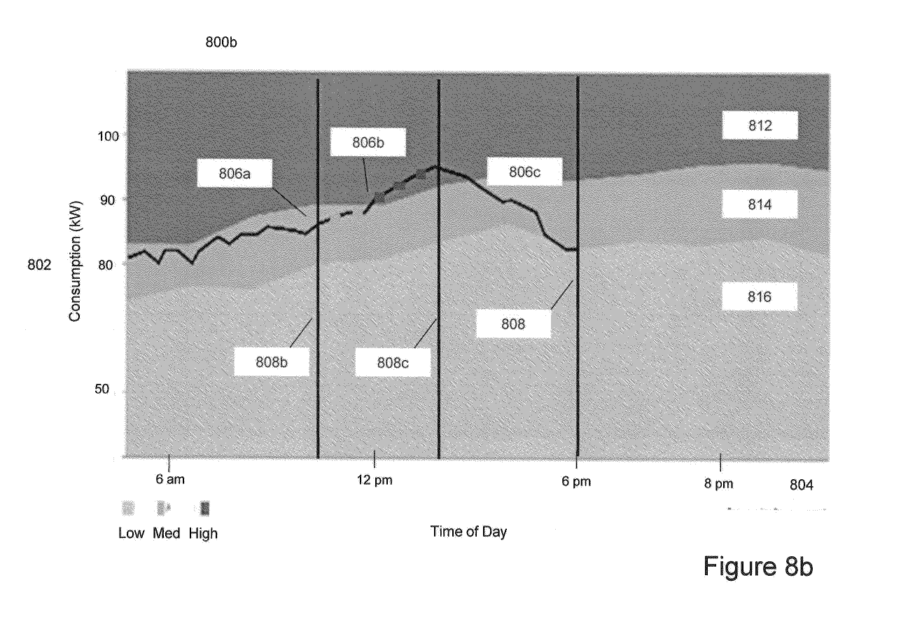

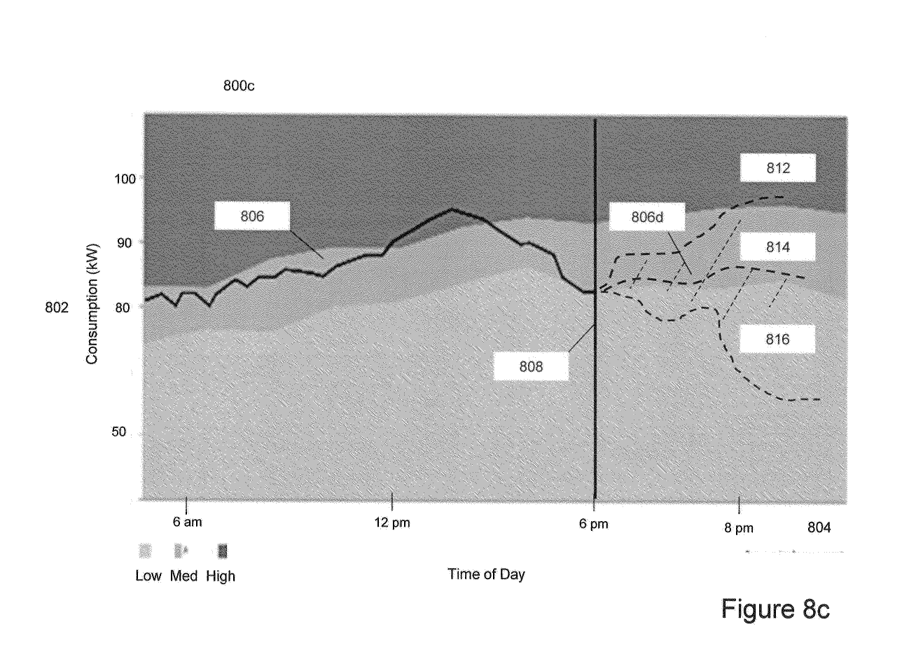

Referring to FIGS. 8a-8c graphical representations of various ranges data of consumption levels are provided for additional aspects of an embodiment. In particular, FIG. 8a shows line graph 800a representing power consumption over a period of time at a specific site. Y-axis 802 shows an exemplary range of power consumption amounts. X-axis 804 shows an exemplary range times of power consumption amounts. The x and y-axes in graph 800a-c have linear scales, but in other embodiments, either axis may have non-linear scales (e.g. disjoint, logarithmic, algorithmic etc.). Line 806 shows a series of datapoints at a series of different times, where each datapoint represents the level of consumption (in the y-axis) at that related time (in the x-axis). Line 806 may be replaced with a series of discrete markers (e.g. dots) representing datapoints at discrete instances of time. In line 806, values between actual data values (i.e. between time intervals) may be interpolated. At a given instance of time (e.g. at 6 p.m., shown by line 808) a specific level of consumption can be shown. This specific level of consumption can map to a consumption gauge, such as gauge 810 which can be generated in concert with graph 800a. Gauge 810 may represent a snapshot of a consumption data in the datapoints at a target time that can be changed via movement of a cursor in a GUI. Line 808 may represent the cursor and the consumption values at that instance of time may be provided in gauge 810. In an embodiment, graphs 800a-c and gauge 810 may be simultaneously generated in a screen on a display of device 106 (FIG. 1). Gauge 810 is comparable to gauge 500 (FIG. 5), including having segments 508A-508C, with green, yellow and red backgrounds. For FIG. 8a, the mapping of the value of line 806 at line 808 does not graphically correspond to the position of the indicator in gauge 810 along its scale; however, it is preferred that there is a correspondence.

Graph 800a has a series of background ranges shown in the plot area of graph 800a, representing bands of ranges of consumption. To facilitate distinguishing among the bands, each band may be shown in a different colour. A value for a band (namely, its range) at a point in time may correspond to a segment as provided in gauge 500 or 600 (FIGS. 5 and 6). In one embodiment, three bands are provided, namely use bands 812, 814 and 816. Band 812 is shown in the lower portion of graph 800a in green and represents a low consumption level for various times along the x-axis. Band 814 is shown in the middle portion of graph 800a in yellow and represents an average of consumption level for various times along the x-axis. Band 816 is shown in the upper portion of graph 800a in yellow and represent a high consumption level for various times along the x-axis. It will be seen that features of the segments described for gauges 500 and 600 can be mapped to the bands for graphs 800a-800c and vice versa.

The sizes and locations of the bands and their boundaries at a given time need to be defined. It will be seen that there is a boundary between the lower portion and the middle portion and a boundary between the middle portion and the upper portion. In one embodiment, determination of the values of the ranges for the bands and boundaries may be established via distribution analysis, based on historic consumption data for the site and/or data from one or more acceptable peer(s) comparable to the site.

In one embodiment, one or both of the boundaries are determined using such a distribution analysis of consumption data. For example, the bands may represent approximate “thirds” for a range of consumption levels, where the middle portion represents the “middle” third of the distribution, the lower portion represents the low third of the distribution and the upper portion represents the upper third of the distribution. The ranges for the bands may be based on the mean or median of the distribution. For example, the consumption data can be assumed to follow a normal (Gaussian) distribution. The center of the distribution can be considered to be the middle of the middle band. The center of the distribution can be the mean or median of the consumption values. The lower boundary may be set at values that are a factor of a standard deviation. For example, the lower boundary in one embodiment is set to be ⅙ of a standard deviation lower the center, where ⅙ is half of ⅓ of the band. The upper boundary can be set at values that are ⅙ of a standard deviation above the center. Other factors, equations and offsets may be used and other distributions may be used (e.g. log-normal, Pareto, Poisson, exponential and others). With a normal distribution, at a particular point in time, the consumption data can be shown as per gauge 500 (FIG. 5) where each segment 508 is approximately the same size. It will be appreciated that other factors for boundary values can be applied (e.g. ½, ⅓, ¼ of a standard deviation, etc.).

Further details are provided on determining specific boundaries for ranges for consumption data. In one embodiment a distribution can be generated from consumption data for a site for a previous period of time. For a non-residential site, the period of time may be measured in business days, e.g. consumption data for the previous twenty (20) business days. Any range of data may be used (e.g. from 0 day to 3 years or more). One embodiment examines energy consumption at a site at continuous points in time and compares the value to historical consumption values. An embodiment estimates the mean and standard deviation at a particular time point for the data based a modelling assumption that the distribution of data values follows a normal distribution. A boundary for the medium and higher band may be set by one or more parameters. In one embodiment one parameter is used and is set to approximately 0.5 (in one embodiment it is set at 0.49) of a standard deviation above the mean. Using the same parameter, a boundary for the medium and lower band is set at approximately 0.5 of a standard deviation below the mean. With these boundaries, approximately one third of the consumption values at a point in time over the historical period are located in the higher band (i.e. at or above the boundary between the middle and higher band; approximately one third of the consumption values at that time are located in the middle band; and approximately one third of the consumption values are located in the lower band. Other values for portions of a standard deviation can be used. Different values can be used for the upper and lower boundaries. Per FIG. 8a(ii), for a given point in time in graph 800a, gauge 810 may reflect those bands by showing its segments as evenly spaced segments and having the current datapoint centered in the middle of the middle segment. The boundaries between the segments are based on the portions of the standard deviation (0.49 as noted in this example). The boundaries of the segments in gauge 810 may map to the boundaries of the bands in graph 800a at the relevant point in time. However, in other embodiments, the boundaries of the segments in gauge 810 have different boundaries—for example boundaries of the segments may follow layouts described for gauges 500 and 600.

In another embodiment, visual presentation of the scale of each of the bands can be varied. In some distributions, the lower and/or middle sections may have a concentrated number of values therein, thereby leading to a skewing of the weighting of the distributions. As such, if the bands were displayed in a linear manner, the lower and/or middle bands would occupy a very small portion of graph 800a. In such situations, the y-axis may be adjusted to widen the scale where there is a higher concentration of values and/or shrink the scale where there is a lower concentration. This adjustment of boundaries can be applied to any graphical representation of data described herein (for example to graphs 800b and 800c).

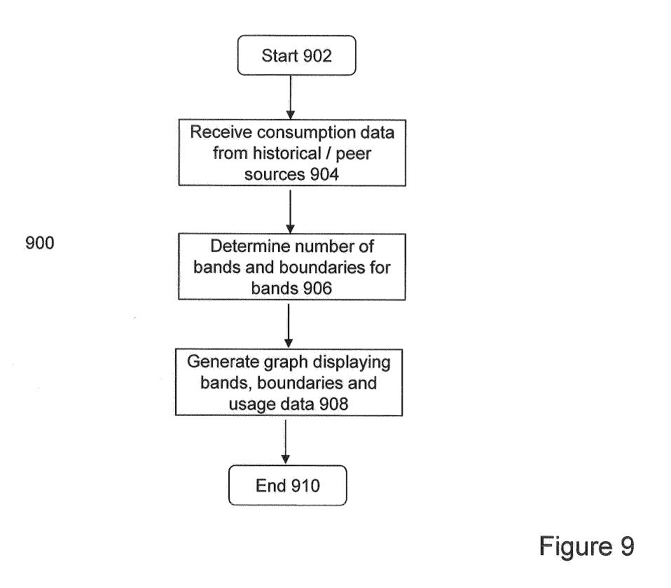

FIG. 9 shows flow chart 900 outlining an exemplary data mapping process in processing historic data by an embodiment. It may be executed or controlled in whole or in part by server 104. Therein, data analysis module 212B (FIG. 2) may provide programming code for execution on processor 202 (FIG. 2) to effect execution of the process. The process may also operate in whole or in part on device 106.

As noted above, an embodiment processes historic consumption data to generate a usage graph, such as graph 800a. The data can be any type of data described herein. After start process 902, such data is received in process 904.

Next at process 906, determinations are made on parameters for the bands and the boundaries. As noted above, one model assumes that the data follows a normal distribution and that three bands are to be presented. Other models and a different number of bands may be selected.

Next at process 908, calculations are made using the identified boundaries and graphical representations of graph 800a are generated and displayed in the GUI. Once the graph is generated, it can be updated. Process 908 may also generate gauge 810 in association with the time marked by a cursor on graph 800a, per FIG. 8a. Flow chart 900 ends at process 910.

As noted above, one feature of graph 800a is that it provides a historical view of consumption data. As part of a user's experience, cursors can be generated and moved on graph 800a in the GUI to provide specific snapshots of the consumption data. In one embodiment, line 808 is provided as a marker for an instant of time in graph 800a. The placement of line 808 can be moved by a viewer along x-axis 804. For the present example, line 808 shows the consumption data for 6 p.m. on the given day. Gauge 810 shows consumption data at 6 p.m. in the previously described format. As line 808 is moved to different times, the values shown in gauge 810 are reflected to represent the consumption value for the noted times. As such, a viewer is provided with historic data in graph 800a and instantaneous usage data in gauge 810. This assists in presenting historic and current consumption data simultaneously in an understandable format to the viewer. In one embodiment graph 800a and gauge 810 are generated on one screen (window, pane, etc.) in a GUI on a display of a computer. In other embodiments, graph 800a and gauge 810 are shown to be linked (e.g. through a “pop-up” window for gauge 810.

Turning back to FIGS. 8b and 8c, further details are provided on another aspects of an embodiment. As shown in FIGS. 8b and 8c, graphs 800b and 800c produce a historic chart of consumption at a site over a period of time. An embodiment also provides data interpolation and data extrapolation features. Each is discussed in turn.

Referring to FIG. 8b, an embodiment provides data interpolation features for the dataset. For graph 800b, the consumption line is shown in three parts, 806a, 806b and 806c, where line 806a and 806c represent data from a dataset and line 800b represents interpolated data from the dataset. Data may need to be interpolated if data is not available for gaps in time. For example, graph 800b may show real time consumption data for a site for a given day. As long as the meters and communication links are functioning, an embodiment can provide real time mapping of consumption to graph 800b. However, if there is a failure in the data reporting chain, for example between times indicated between lines 808b and 808c, then an embodiment does not have accurate data to map to graph 800b in that time. As such, to cover the gap period, an embodiment interpolates data within the gap period. The interpolated data may use historical data averages at the same or comparable time(s) from the and/or from peers. The interpolated data may be shown in a different visual scheme from actual data. In graph 800b, line 806b is shown as a dotted line.

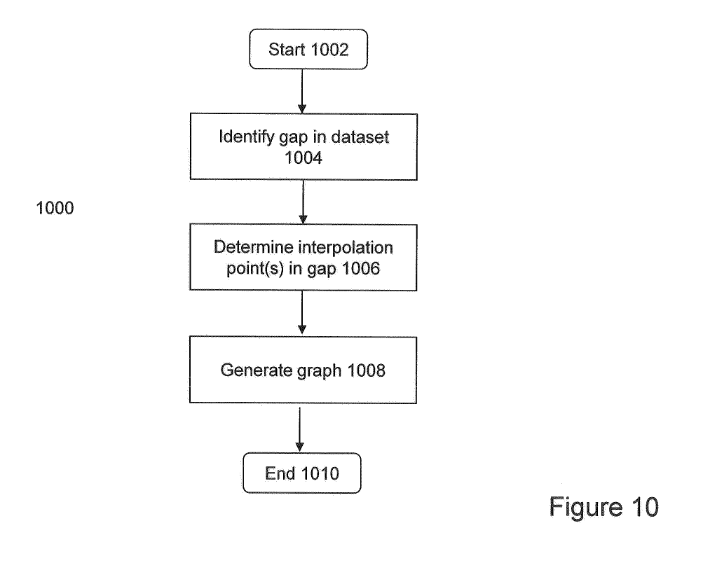

FIG. 10 shows flow chart 1000 outlining an exemplary data interpolation applied to historic data by an embodiment. It may be executed or controlled in whole or in part by server 104. Therein, data analysis module 212B (FIG. 2) may provide programming code for execution on processor 202 (FIG. 2) to effect execution of the process. The process may also operate in whole or in part on device 106.

As noted above, an embodiment processes historic consumption data to generate a usage graph, such as graph 800b. The data can be any type of data described herein. After start process 1002, a gap in the data is identified in process 1004.

Next at process 1006, a determination is made on the datapoints to be interpolated in the gap. The interpolated datapoints may be generated by accessing historical data for the site or its peer(s) around the time(s) of the gap and averaging functions can be used to generate interpolated values. Functions can take into account the time of day, the season, weather conditions and other factors. Straight line interpolations may also be used.

Next at process 1008, calculations are made using the actual and interpolated data and graphical representations of graph 800b are generated and displayed. Process 1008 may also generate gauge 810 in association with graph 800b. Once the graph is generated, it can be updated. Flow chart 1000 ends at process 1010.

Referring to FIG. 8c, an embodiment provides data extrapolation features for the dataset. For graph 800c, the time indicated by line 808 may be at the end of the dataset for the site. For possible expected consumption values following that time, an embodiment extrapolates a range possible use values. The extrapolated data can use historical data averages at the same or comparable time(s) from the and/or from peers. The amount of time forward from time at line 808 likely increases the variations of possible extrapolated datapoints. As such, graph 800c shows region 806d that reflects the extrapolated datapoints following line 808. Region 806d is bounded by an upper limit line and a lower limit line, which delimit a range of extrapolated consumption values from line 808 onward. An estimated value is also plotted in region 806d. The upper and lower limits can be defined in terms of statistical deviations from the normal of the estimated value, where the deviations may get larger as the estimates move further in time from line 808. Other factors may affect the deviations, including historical data and external events (expected or received). It can be seen that region 806d starts at line 808 with values very near the consumption value at line 808, but then a larger number of possible consumption values generally are provided the further the extrapolated data is extended from that time. The extrapolated data can be shown in a different visual scheme from actual data. In graph 800c, region 806d is shown as a dotted region with dotted boundary lines.

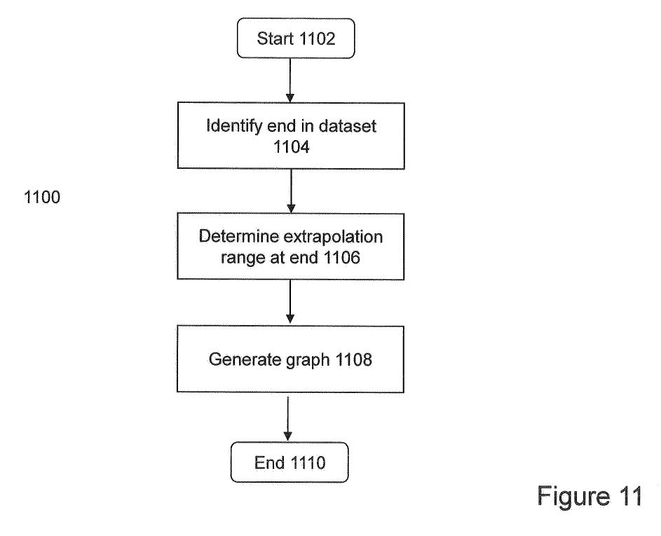

FIG. 11 shows flow chart 1100 outlining an exemplary data extrapolation for historic data by an embodiment. It may be executed or controlled in whole or in part by server 104. Therein, data analysis module 212B (FIG. 2) may provide programming code for execution on processor 202 (FIG. 2) to effect execution of the process. The process may also operate in whole or in part on device 106.

As noted above, an embodiment processes historic consumption data to generate a usage graph, such as graph 800c. The data can be any type of data described herein. After start process 1102, an end of the dataset is identified in process 1104.

Next at process 1106, extrapolated datapoints following the end of the dataset are determined. The extrapolated datapoints may be generated by accessing historical data for the site or its peer(s) around the end time and averaging and predictive functions may be used to generate extrapolated values. Functions can take into account the time of day, the season, weather conditions and other factors. Straight line extrapolations can also be used.

Next at process 1108, calculations are made using the actual and extrapolated data and graphical representations of graph 800c are generated and displayed. Process 1108 may also generate gauge 810 in association with graph 800c. Once the graph is generated, it can be updated. Flow chart 1100 ends at process 1110.

Now, features relating to another aspect of an embodiment that provide data modelling for different scenarios are described. It is noted that flow chart 400 (FIG. 4) provides analysis of a dataset comprising consumption data from a plurality of data sources. As such, the analysis in flow chart 400 provides information on a how a particular datapoint compares a dataset in a certain population. An embodiment also provides a data scenario tool, which can access model data and generate different scenarios for a given dataset. The scenarios may relate to models for consumption, usage, emission targets and/or other requirements. Rebate information may be incorporated into the scenario data. For example, one consumption program may provide additional rebates on consumption rates when target consumption savings are achieved. “Time of use” information may be incorporated into the scenario data. For example, different cost rates may apply to a consumable (e.g. water, electricity) depending on when it is consumed (e.g. during the working day, during weekends, at night, etc.). Scenarios may be developed and presented that estimate consumption or usage for a consumable based on a dataset. As such the scenarios may represent other datapoints that are not necessarily based on data from peers. This scenario data may be used to augment a visual representation of a dataset generated by data visualization module 212C.

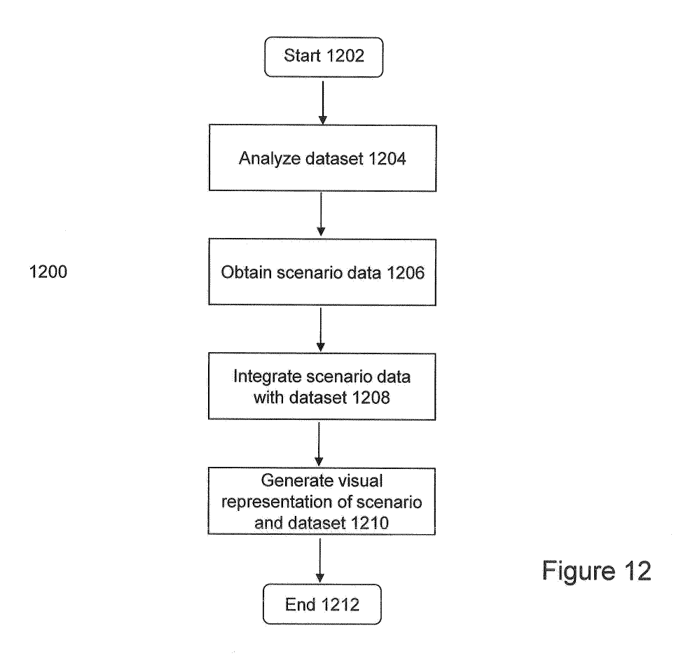

Referring to FIG. 12, flow chart 1200 shows an exemplary data scenario generation process which may be provided by server 104 (FIG. 1). Therein, data scenario module 212D (FIG. 2) may provide programming code for execution on processor 202 (FIG. 2) to effect execution of the process. The process may also operate in whole or in part on device 106. In illustrating features of flow chart 1200, an exemplary dataset relating to energy usage of a house within a city block is used.

The process is initiated at start process 1202, which may be initiated by device 106 after receiving a request from device 106 through user 108. At process 1204, a dataset is obtained and analyzed. Process 1204 may incorporate one or more functions of processes in flow chart 400 (FIG. 4), including processes 440, 406 and 408. The dataset may be adjusted to filter, sort, localize, level and/or normalize the dataset to provide a calibrated dataset. Adjustments may be made to reflect its minimum and maximum values and comparable adjustments may be made to its scale (504, FIG. 5) when a visual representation is generated.

Next, at process 1206, scenario data is obtained. Scenario data may be stored in database 110. Scenario data may model different hypothetical or actual performance targets or traits for a dataset. For example, a scenario may include target usage data relating to consumption targets, emission targets, cost targets, rebate offers, time of use charges for utilities, tariff charges on excess usage and other goals and/or targets. Scenario data may relate to a particular data source (e.g. a given building) and may reflect changes implemented at the source (e.g. installing high-efficiency lighting, replacement of water heater, additional of new wing, etc.).

Scenario data may provide data reflecting effects of such change(s). The data may show differences (e.g. in saved consumption/emissions/costs and/or additional consumption/emissions/costs) that are projected as a result of such change(s). Changes may be show over different time periods (e.g. short term and long term), with a projected “payback” time incorporated.

When an embodiment determines a difference, the results may be displayed in a “raw” form, where basic difference information is displayed. For example, if the difference is determined to be a savings of 100 litres of gasoline, the result may simply state “100 litres of gasoline are saved” or a comparable message. However, an embodiment also provides a facility to provide an analogous report to the raw data where the raw data is converted to a second set of units and that may be further converted to a suitable paradigm using the second units. For example, if the raw data indicates a certain amount of gasoline that is used, an analogous report may convert the gasoline units to units related to carbon emissions. The conversion is based on how many units of gasoline produce a unit of carbon emission. Then the savings may be expressed in terms of carbon savings. Further the amount of carbon savings can be further converted to other paradigms associated with carbon usage. For example, the total amount of carbon emissions saved can then be converted to units such as an equivalent number of cars that would be removed from the streets that would have produced the calculated carbon emissions saved. It will be seen that other conversions can be provided. As an exemplary non-exhaustive list, the following units can be converted among each other, provided that a suitable conversion rate is provided: energy consumed/saved, electricity consumed/saved, carbon generated/saved, costs, payback time, heat generated/saved, water consumed/saved and others. Conversions can be provided through one or more conversion steps among units.

Next, at process 1208, the scenario data is integrated with the dataset. The scenario data may define one or more boundaries (510, FIG. 5) for the dataset, based any goals or limits defined for the selected scenario.

With the above noted processes, a scenario dataset can be analyzed and segmented in a similar fashion to a population consumption dataset, described earlier. As such, a visual representation of a scenario dataset may also be generated.

At process 1210, a visual representation of the scenario data is produced. Process 810 may incorporate one or more functions of processes in flow chart 400 (FIG. 4), including process 410 to generate a graphical representation, such as any representation shown in FIGS. 5-7.

In addition to the speedometer graphical representation, an embodiment may display results in other graphical representations. For example a series of line graphs can be provided with multiple graphs generated thereon. The x-axis can represent time units (e.g. days) and the y-axis can represent a consumable (e.g. energy used/saved). In one embodiment, one graph can be provided to plot current energy usage for a subject entity (e.g. a building) as calculated. A second graph can be provided to plot current energy usage for a group of entities relating to the subject entity (e.g. buildings in a block). A third graph can be provided to plot the current energy usage for another group of entities (e.g. best buildings in the dataset). Other plots can be provided.

The embodiment also provides direct control of function(s) of an entity being evaluated. For example for energy usage for a building, the embodiment can provide for direct and/or scheduled control of one or more operational components in the building (e.g. lights, heat, HVAC, etc.).

Also, for the graphical representation, when a target indicator is provided, an embodiments also provides an ability to change the setting of the target indicator (e.g. indicator 512B, FIG. 5), by dragging and changing the indicator directly through the GUI. As the indicator changes, this may have an effect on the current operating characteristics of the consumable/emission/cost being plotted. An embodiment may provide a direct feedback control to change operating characteristics of one or more components relating to the data being plotted. Again, for example, for energy usage for a building, changing the target indicator (or another indicator) may cause a change in one or more operational components in the building (e.g. lights, heat, HVAC, etc.).

For the scenario data, once the scale and segments are determined for its visual representation, then a particular datapoint for a consumed resource at a particular location may be mapped onto the representation. Once its location within the scenario dataset is determined, the particular datapoint may be shown as an indicator such as indicator 512A (FIG. 5). For example, for a scenario dataset showing best times to do laundry for a household, an indicator may be provided representing the current energy usage of the house.

As part of the scenario dataset, one or more (consumption) goals may be provided. Each goal may be based on a different combination of savings parameters (e.g. time of use saving, amount of use reductions, rebate targets, etc.) and/or on different savings progressions (e.g. mild savings, moderate savings, aggressive savings).

Based on any significant difference between the current usage datapoint (per indicator 512A, FIG. 5) and the goal (per indicator 512B, FIG. 5), data scenario module 212D may determine a progression to move the tracked usage from its current level to the target level. For example a reduction of usage may be calculated to have a daily incremental reduction of usage over a period of time to reduce the current usage level to the target level. Such a progression rate may be identified to change a usage pattern of a device (e.g. a water heater) associated with the first datapoint to the goal.

In another embodiment, a visual representation of a population's consumption data may be generated (as noted above) and scenario data may then be accessed. A particular datapoint relating to a specific location's consumption data may be provided in the visual representation (e.g. as indicator 512A). Scenario data (as described above) may be analyzed to identify a goal for that a particular datapoint and the goal may be provided in the visual representation (e.g. as indicator 512B). For example, using consumption data from Table A, exemplary goal data in Table B may be provided for analysis.

TABLE B

| Goal | Value | Note |
|---|---|---|
| Mild Savings | 1,750 | Implements free savings |
| Moderate Savings | 1,256 | Implements day of use + |
| | | rebate programs |
| Aggressive Savings | 750 | Implements aggressive |
| | | energy savings programs |

Goal data may be absolute (providing set values as noted in Table B) and/or may be expressed as a percentage (e.g. a percentage reduction from the current usage rate).

An embodiment also provides control features to implement a plan to move the current consumption level towards the identified goal. Part of the control features utilize identified consumption value of a consumable for a given location. In particular, an embodiment can have direct control over one or more systems (e.g. lighting, heating, water circulation, HVAC, etc.) and can implement signals that are generated and transmitted from server 104 to start, stop and/or reduce the usage. Control module 212E (FIG. 2) may provide programming code for execution on processor 202 (FIG. 2) to effect execution of the process. The control module may generate control signals to control operation parameters of a device (e.g. to the above noted water heater to control when it is operated and at what temperatures the heater is set to) to implement the progression rate. The controls can be provided to control like groups of items. For example, controls can be provided to manage different types of utilities in a location (e.g. heat, water, HVAC, etc.) or all the same utilities in a location (e.g. all water usage in a city block). Part of the control features may provide a trigger to recalculate a visual representation of consumption data as the controls are implemented (per process 402, FIG. 4). As such, a matrix of control signals can be provided to control multiple devices. An embodiment can provide a separate plan for each device, but an overall plan can be provided that has coordinated controls over parameters for multiple devices.

It will be appreciated that all modules described herein for server 104 and device 106 can be implemented using known programming techniques, languages and algorithms. Although the modules described are implemented in server 104, it will be appreciated that some functions of the modules may be provided in a separate server that is in communication with server 104 and/or device 106, or even provided in device 106 itself. The titles of the modules are provided as a convenience to provide labels and assign functions to certain modules. It is not required that each module perform only its functions as described above. As such, specific functionalities for each application may be moved between modules or separated into different modules. Modules may be contained within other modules. Different signalling techniques may be used to communicate information between applications using known programming techniques. Known data storage, access and update algorithms allow data to be shared between applications. It will further be appreciated that other applications and systems on server 104 or device 106 may be executing concurrently using programming techniques known in the art.

It will be appreciated that the embodiments relating to client devices, server devices and systems may be implemented tangible and intangible forms. For example, embodiments may be provided in a tangible form in a combination of electronic hardware, firmware and software and other tangible forms. The firmware and software may be implemented as a series of processes, applications and/or modules that provide the functionalities described herein. The algorithms and processes described herein may be executed in different order(s). Interrupt routines may be used. Data may be stored in volatile and non-volatile devices described herein and may be updated by the hardware, firmware and/or software.

As used herein, the wording “and/or” is intended to represent an inclusive-or. That is, “X and/or Y” is intended to mean X or Y or both.

In this disclosure, where a threshold or measured value is provided as an approximate value (for example, when the threshold is qualified with the word “about”), a range of values will be understood to be valid for that value. For example, for a threshold stated as an approximate value, a range of about 25% larger and 25% smaller than the stated value may be used. Thresholds, values, measurements and dimensions of features are illustrative of embodiments and are not limiting unless noted. Further, as an example, a “sufficient” match with a given threshold may be a value that is within the provided threshold, having regard to the approximate value applicable to the threshold and the understood range of values (over and under) that may be applied for that threshold.

The present disclosure is defined by the claims appended hereto, with the foregoing description being merely illustrative of embodiments of the disclosure. Those of ordinary skill may envisage certain modifications to the foregoing embodiments which, although not explicitly discussed herein, do not depart from the scope of the disclosure, as defined by the appended claims.

1. A method of processing data, comprising:
determining a start time and an end time in a set of datapoints comprising a plurality of data relating to a plurality of times;
generating a first graphical representation of the set of datapoints on an output device, the first graphical representation including
a time axis;
a value axis;
a plot of the set of datapoints between the start time and the end time;
a plot of a first band relating to the set of datapoints between the start time and the end time;
a plot of a second band relating to the set of datapoints between the start time and the end time;
a plot of a first boundary of a first band of values relating to the set of datapoints between the start time and the end time;
a plot of a second boundary of a second band of values relating to the set of datapoints between the start time and the end time; and
a cursor for marking a target time between the start time and the end time; and
generating a second graphical representation of the datapoints at the target time on the output device with the first graphical representation, the second graphical representation including
an axis for a scale for a range of values for the set of datapoints at the target time;
a first marker a first boundary for a first segment in a scale for a range of values for the set of datapoints at the target time;
a first graphical feature representing the first segment, the first graphical feature spanning a first length along the axis;
a second graphical feature representing a second segment in the set of datapoints, the second graphical feature spanning a second length along the axis; and
a first indicator for a first datapoint at the target time.

2. The method of processing data as claimed in claim 1, further comprising:
for the plot of the set of datapoints in the first graphical representation, interpolating datapoints for values between a third time and a fourth time where data is not available.

3. The method of processing data as claimed in claim 1, further comprising:
for the plot of the set of datapoints in the first graphical representation, extrapolating datapoints for values after a third time when data from the datapoints after that third time is not available.

4. The method of processing data as claimed in claim 1, wherein:
the plot of the first boundary of the first band of values relating is determined from a factor of a standard deviation from mean values for the set of datapoints between the start time and the end time.

5. The method of processing data as claimed in claim 4, wherein:
the standard deviation is based on a normal distribution for the set of datapoints.

6. The method of processing data as claimed in claim 1, wherein:
the scale has a plurality of markers that are consistent in scale between the start point and the end point;
the second length is approximately equal to the first length; and
the range of datapoints of the first segment has a different scale to a range of datapoints in the second segment,
wherein:
the first graphical feature is provided in a first colour; and
the second graphical feature is provided in a second colour.

7. The method of processing data as claimed in claim 6, further comprising:
generating in the second graphical representation a second indicator for a second datapoint in the set of datapoints,
wherein the second datapoint represents a target value or a historic value for the first datapoint.

8. The method of processing data as claimed in claim 6, further comprising:
generating a second graphical representation with the graphical representation for a second set of datapoints,
wherein the second set of datapoints relates to the consumption data, but for a timeframe that differs from a timeframe associated with the set of datapoints.

9. The method of processing data as claimed in claim 6, wherein:
the set of datapoints represents consumption data for a resource; and
the first datapoint represents real time consumption of the resource at a location.

10. The method of processing data as claimed in claim 9, further comprising:
analyzing model data to identify a goal for consumption of the resource at the location; and
generating in the graphical representation a second indicator for the goal.

11. The method of processing data as claimed in claim 10, further comprising:
determining a progression rate to change usage of the resource at the location from the first datapoint to the goal; and
generating control signals to control a device to implement the progression rate.

12. The method of processing data as claimed in claim 12, wherein:
the goal is based on at least one of time of using savings and a rebate program.

13. A system for processing data, comprising:
a processor;
a display device;
a first module to provide instructions for the processor to process a set of datapoints to generate a first graphical representation of the datapoints on the display device, the first graphical representation including
a time axis;
a value axis;
a plot of the set of datapoints between the start time and the end time;
a plot of a first band relating to the set of datapoints between the start time and the end time;
a plot of a second band relating to the set of datapoints between the start time and the end time;
a plot of a first boundary of a first band of values relating to the set of datapoints between the start time and the end time;
a plot of a second boundary of a second band of values relating to the set of datapoints between the start time and the end time; and
a cursor for marking a target time between the start time and the end time;
a second module to provide instructions for the processor to process the set of datapoints to
determine a scale for a range of values of the set of datapoints at the target time;
determine a first segment in the range of values of the set of datapoints at the target time; and
determine a second segment in the range of values of the set of datapoints at the target time;
and
a third module to provide instructions for the processor to generate a second graphical representation of the datapoints for the display device with the first graphical representation, by generating data for the second graphical representation relating to
an axis for the scale;
a first marker for the first boundary;
a first graphical feature representing the first segment, the first graphical feature spanning a first length along the axis;
a second graphical feature representing the second segment, the second graphical feature spanning a second length along the axis; and
a first indicator for a first datapoint in the set of datapoints.

14. The system for processing data as claimed in claim 13, wherein the first module further provides instructions for the processor to:
interpolate datapoints for values between a third time and a fourth time for the plot of the set of datapoints when current data is not available.

15. The system for processing data as claimed in claim 13, wherein the first module further provides instructions for the processor to:
extrapolate datapoints for values after a third time when data from the datapoints for the plot of the set of datapoints after that third time is not available.

16. The system for processing data as claimed in claim 13, wherein the first module further provides instructions for the processor to:
determine the first boundary from a factor of a standard deviation from mean values for the set of datapoints between the start time and the end time.

17. The system for processing data as claimed in claim 13, further comprising a fourth module to provide instructions for the processor to:
analyze model data to identify a goal for consumption of the resource at the location; and
generate additional data for the graphical representation for a second indicator for the goal.

18. The system for processing data as claimed in claim 16, wherein:
the second length is approximately equal to the first length; and
the range of datapoints of the first segment has a different scale to a range of datapoints in the second segment.

19. The system for processing data as claimed in claim 18, wherein the third module provides instructions for the processor to:
generate data to produce the first graphical feature in a first colour; and
generate data to produce the second graphical feature in a second colour, wherein
the first segment represents a range of target values in the set of datapoints; and
the data and the additional data for the graphical representation are provided to the display device, the display device being a display associated with a device in communication with the system.

20. The system for processing data as claimed in claim 16, further comprising a fifth module to provide instructions for the processor to:
utilize the goal and the first datapoint to control operation parameters of one device at the location.
